(19) United States
(12) Patent Application Publication
(10) Pub. No.: US 2026/0153683 A1
(43) Pub. Date: Jun. 4, 2026

(54) ALIGNMENT MEMBER

(71) Applicant: Sumitomo Electric Optifrontier Co., Ltd., Kanagawa (JP)

(72) Inventor: Shinsuke KURINO, Kanagawa (JP)

(21) Appl. No.: 19/122,282

(22) PCT Filed: Sep. 22, 2023
(86) PCT No.: PCT/JP2023/034457

§ 371 Date: Apr. 18, 2025

(30) Foreign Application Priority Data
Oct. 21, 2022 (JP) 2022-169021

(51) Int. Cl. G02B 6/36

(52) U.S. Cl. CPC G02B 6/3616

(57) ABSTRACT

An alignment member includes a base unit, and an alignment mechanism unit including a movable base portion disposed overlapping the base unit, an alignment lid disposed overlapping the movable base portion, and a movable member provided in at least one of the movable base portion and the alignment lid. The movable base portion is pivotally connected to the base unit. The alignment lid is configured to be pivoted relative to the movable base portion. When the movable base portion and the alignment lid are overlapped with each other, a slit is formed between the movable base portion and the alignment lid, the slit being open on a side opposite to a connection point between the slit and the base unit and being configured to accommodate a plurality of optical fibers in parallel.

### TECHNICAL FIELD

The present disclosure relates to an alignment member.

This application claims priority based on Japanese Application No. 2022-169021 filed on Oct. 21, 2022, and incorporates by reference all of the contents of the above-mentioned Japanese application.

### BACKGROUND ART

Patent Literature 1 discloses an optical fiber holder that holds a plurality of optical fibers in an aligned state. Also, Patent Literature 2 discloses a ribboning assembly that includes an alignment device.

### CITATION LIST

### Patent Literature

Patent Literature 1: WO2012/140991A1
Patent Literature 2: US2020/0278511A

### SUMMARY OF INVENTION

In order to achieve the above object, an alignment member according to one aspect includes:
a base unit; and
an alignment mechanism unit including:
   a movable base portion disposed overlapping the base unit;
   an alignment lid disposed overlapping the movable base portion; and
   a movable member provided in at least one of the movable base portion and the alignment lid,
in which the movable base portion is pivotally connected to the base unit,
the alignment lid is configured to be pivoted relative to the movable base portion,
when the movable base portion and the alignment lid are overlapped with each other, a slit is formed between the movable base portion and the alignment lid, the slit being open on a side opposite to a connection point between the slit and the base unit and being configured to accommodate a plurality of optical fibers in parallel,
in an initial state, the movable member is pulled or biased in a direction to block the slit, and at least a part of the movable member protrudes so as to narrow or block the slit, and
the movable member is configured to be moved in a direction away from the slit when pressed.

### BRIEF DESCRIPTION OF DRAWINGS

FIG. 1 is a perspective view of an alignment member according to a first embodiment when an alignment mechanism unit is in an open state.

FIG. 2 is a perspective view of the alignment member according to the first embodiment when the alignment mechanism unit is in a closed state.

FIG. 3 is a perspective view illustrating a base unit and the alignment mechanism unit of the alignment member.

FIG. 4 is a diagram illustrating a state in which pivoting of a movable base portion and an alignment lid is restricted by a restricting portion.

FIG. 5 is a diagram illustrating a state in which the movable base portion and the alignment lid are overlapped with each other and a movable member is in an initial state position.
FIG. 6 is a diagram illustrating a state in which, with the movable base portion and the alignment lid overlapping each other, the movable member is pressed in a direction to open a slit and moves in a direction away from the slit.

FIG. 7 is a perspective view of an alignment member according to a second embodiment.

### DESCRIPTION OF EMBODIMENTS

### Problem to be Solved by This Disclosure

When aligning a plurality of optical fibers, if the optical fibers overlap each other, for example, the aligning work must be redone. For this reason, when aligning a plurality of optical fibers, there is a need to align the plurality of optical fibers in a state where each optical fiber is correctly positioned.

An object of the present disclosure is to provide an alignment member that can reliably align a plurality of optical fibers.

### Effects of This Disclosure

According to the present disclosure, it is possible to provide an alignment member that can reliably align a plurality of optical fibers.

### Description of Embodiments of This Disclosure

First, embodiments of the present disclosure will be listed and described.

An alignment member according to one aspect of the present disclosure includes:
(1) a base unit; and
   an alignment mechanism unit including:
      a movable base portion disposed overlapping the base unit;
      an alignment lid disposed overlapping the movable base portion; and
      a movable member provided in at least one of the movable base portion and the alignment lid,
   in which the movable base portion is pivotally connected to the base unit,
   the alignment lid is configured to be pivoted relative to the movable base portion,
   when the movable base portion and the alignment lid are overlapped with each other, a slit is formed between the movable base portion and the alignment lid, the slit being open on a side opposite to a connection point between the slit and the base unit and being configured to accommodate a plurality of optical fibers in parallel,
   in an initial state, the movable member is pulled or biased in a direction to block the slit, and at least a part of the movable member protrudes so as to narrow or block the slit, and
   the movable member is configured to be moved in a direction away from the slit when pressed.

According to this configuration, for example, when the optical fiber is brought into contact with the movable member and pressed, the movable member moves, so that the optical fiber can be accommodated in the slit. After the optical fiber is accommodated, the movable member is pulled or biased in a direction to block the slit, so that at least a part of the movable member protrude so as to narrow or block the slit. Therefore, the optical fiber can be accommodated in the slit simply by moving the movable member, and there is no need to apply force to the movable base portion and the alignment lid. In other words, the slit can be prevented from widening, so that the alignment of the optical fibers accommodated in the slit can be maintained. In this manner, according to the above-described configuration, a plurality of optical fibers can be reliably aligned.
(2) In the alignment member according to (1), the movable member may have a curved surface that is convex in a direction protruding toward the slit, when viewed from a depth direction of the slit.

According to this configuration, the movable member has a curved surface that is convex in the direction protruding into the slit when viewed from the depth direction of the slit, making it easier, for example, to press the optical fiber against the movable member, and as a result, to move the movable member in a direction away from the slit.
(3) In the alignment member according to (1) or (2), the movable member may be configured to be rotated about an axis parallel to a depth direction of the slit.

According to this configuration, the movable member is rotatable around an axis parallel to the depth direction of the slit, so that even when the optical fiber comes into contact with the movable member, excessive frictional force is unlikely to be generated on the optical fiber, making it less likely for the optical fiber to be damaged and making it easier to accommodate the optical fiber into the slit.
(4) In the alignment member according to any one of (1) to (3),
   a pivot axis of the movable base portion and a pivot axis of the alignment lid may be the same axis,
   the base unit may include a rail portion for moving the movable base portion and the alignment lid along the pivot axis of the movable base portion and the alignment lid, and a restricting portion for restricting pivoting of the movable base portion and the alignment lid,
   the restricting portion may be provided at a first position of the rail portion, and
   when the movable base portion and the alignment lid is moved to the first position via the rail portion, the pivoting of the movable base portion and the alignment lid may be restricted by the restricting portion, and the movable base portion and the alignment lid may be maintained in an overlapped state.

According to this configuration, when the movable base portion and the alignment lid move to the first position of the rail portion via the rail portion, the pivoting of the movable base portion and the alignment lid is restricted by the restricting portion, so that the slit does not widen. In other words, the movable base portion and the alignment lid can be maintained in a state where they are overlapped with each other simply by moving the movable base portion and the alignment lid to the first position of the rail portion. Therefore, according to the above-described configuration, the pivoting of the movable base portion and the alignment lid is restricted by the restricting portion, so that the slit does not widen, which improves workability when accommodating the optical fibers in the slit and makes it possible to maintain the alignment of the optical fibers.
(5) In the alignment member according to (4), the rail portion may be a shaft member of the pivot axis.

According to this configuration, the rail portion is the shaft member for the pivot axis of the movable base portion and the alignment lid, so that the alignment member can have a simple configuration while reliably aligning a plurality of optical fibers.
(6) The alignment member according to any one of (1) to (5) may include two alignment mechanism units and a placement unit for placing an optical fiber holder configured to hold the plurality of optical fibers, where
   the placement unit may be provided between the two alignment mechanism units.

According to this configuration, the plurality of optical fibers can be aligned from both sides in advance before the plurality of optical fibers are held in the optical fiber holder, making it easier to hold the plurality of optical fibers in the optical fiber holder.
(7) The alignment member according to any one of (1) to (5) may further include a holding mechanism unit for holding the plurality of optical fibers, where
   the alignment mechanism unit and the holding mechanism unit may be arranged side by side in a longitudinal direction of the optical fiber held by the holding mechanism unit.

According to this configuration, the alignment mechanism unit and the holding mechanism unit are arranged side by side in the longitudinal direction of the optical fiber held by the holding mechanism unit, so that alignment and holding of the plurality of optical fibers can be performed by a single alignment member.
(8) In the alignment member according to any one of (1) to (7), where the movable member may be arranged in an initial state position by being pulled in a direction to block the slit by a magnetic force.

According to this configuration, the movable member is pulled by the magnetic force in a direction to block the slit, and is thereby placed in the initial state position. Therefore, according to the above-described configuration, the movable member can be attracted in a direction to stably block the slit using simple means.

### Details of Embodiments of This Disclosure

Hereinafter, an alignment member according to an embodiment of the present disclosure will be described with reference to the drawings. The present disclosure is not limited to these examples, but is defined by the scope of the claims, and is intended to include all modifications within the meaning and scope equivalent to the scope of the claims. In the following description, front-rear, left-right, and up-down directions correspond to directions of arrows appropriately illustrated in each drawing. In each drawing, a symbol U indicates an upward direction. A symbol D indicates a downward direction. A symbol F indicates a forward direction. A symbol B indicates a backward direction. A symbol L indicates a left direction. A symbol R indicates a right direction.

### First Embodiment

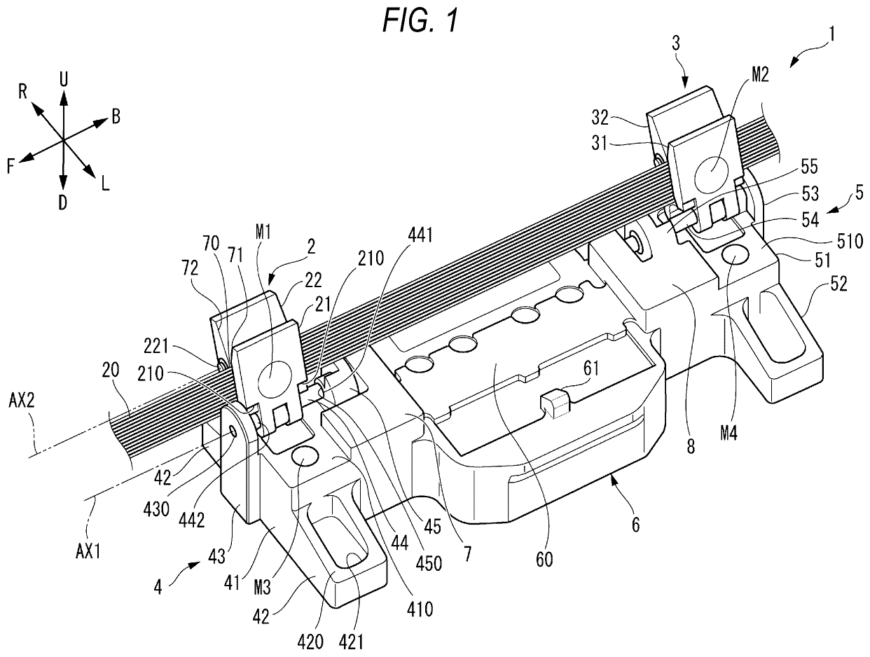

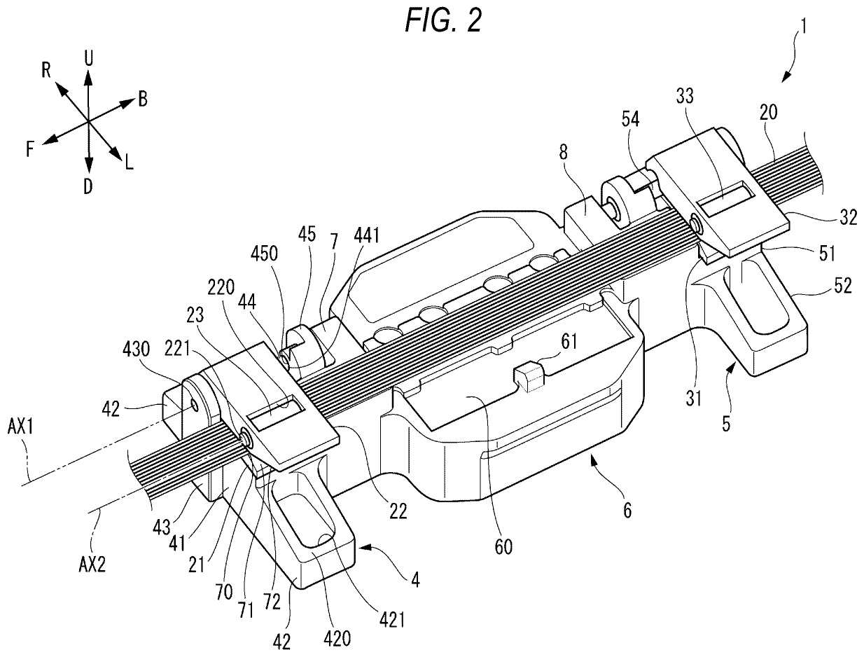

An alignment member 1 according to a first embodiment will be described with reference to FIGS. 1 to 6. The alignment member 1 is for aligning a plurality of single optical fibers in parallel. In the present embodiment, an optical fiber 20 (optical fiber core) in which an outer periphery of a glass fiber consisting of a core and a cladding is coated with a resin will be described as an example. As illustrated in FIGS. 1 and 2, the alignment member 1 holds a plurality of optical fibers 20. The optical fiber 20 is, for example, a single optical fiber having an outer diameter of 200 μm or 250 μm.

The alignment member 1 includes a first alignment mechanism unit 2, a second alignment mechanism unit 3, a first base unit 4, a second base unit 5, a placement unit 6, a first connecting unit 7, and a second connecting unit 8. The first alignment mechanism unit 2 is provided on a front side (in a direction of the arrow F in the figure) of the alignment member 1. The second alignment mechanism unit 3 is provided on a rear side (in the direction of the arrow B in the figure) of the alignment member 1. The first alignment mechanism unit 2 and the second alignment mechanism unit 3 are provided so as to interpose the placement unit 6 therebetween. The first base unit 4 is provided on a front side of the alignment member 1 and below the first alignment mechanism unit 2. The second base unit 5 is provided on a rear side of the alignment member 1 and below the second alignment mechanism unit 3. The first base unit 4 and the second base unit 5 are provided at positions on opposite sides, in the front-rear direction, across the placement unit 6.

The first alignment mechanism unit 2 includes a movable base portion 21, an alignment lid 22, and a movable member 23. The second alignment mechanism unit 3 includes a movable base portion 31, an alignment lid 32, and a movable member 33. The first base unit 4 includes a base body portion 41, a leg portion 42, a support portion 43, a rail portion 44, and a restricting portion 45. The second base unit 5 includes a base body portion 51, a leg portion 52, a support portion 53, a rail portion 54, and a restricting portion 55. The movable base portion 21 and the alignment lid 22 of the first alignment mechanism unit 2 are pivotally connected to the rail portion 44 extending in the front-rear direction of the first base unit 4. The movable base portion 31 and the alignment lid 32 of the second alignment mechanism unit 3 are pivotally connected to the rail portion 54 extending in the front-rear direction of the second base unit 5.

First, the first alignment mechanism unit 2 and the second alignment mechanism unit 3 will be described. The movable base portion 21 of the first alignment mechanism unit 2 is made of a non-magnetic material such as aluminum. A magnet M1 is provided on a surface of the movable base portion 21 facing the first base unit 4. A cutout portion 210 having a concave shape is provided at each of the lower front end portion and the lower rear end portion of the movable base portion 21. The movable base portion 21 is connected to the first base unit 4 so as to be pivoted about an axis of the rail portion 44 of the first base unit 4. A rotation angle of the movable base portion 21 relative to the first base unit 4 is, for example, 100° to 120°. However, the rotation angle of the movable base portion 21 relative to the first base unit 4 need only be smaller than 180°, and is not limited to 100° to 120°.

The alignment lid 22 is connected to the first base unit 4 so as to be pivoted about the axis of the rail portion 44 of the first base unit 4. Since both the movable base portion 21 and the alignment lid 22 are connected to the rail portion 44, the pivot axes of the movable base portion 21 and the alignment lid 22 are the same axis. The alignment lid 22 is configured to be pivoted relative to the movable base portion 21. A rotation angle of the alignment lid 22 relative to the first base unit 4 is, for example, 100° to 120°. However, the rotation angle of the alignment lid 22 relative to the first base unit 4 need only be smaller than 180°, and is not limited to 100° to 120°. At least a part of the alignment lid 22 is made of a magnetic material such as iron. As a result, the alignment lid 22 is configured to be attracted toward the movable base portion 21 by a magnetic force of the magnet M1, and is configured to be pivoted toward the movable base portion 21. When the alignment lid 22 is attracted toward the movable base portion 21 by the magnetic force of the magnet M1, the movable base portion 21 and the alignment lid 22 are overlapped with each other. The alignment lid 22 faces the movable base portion 21 when the movable base portion 21 and the alignment lid 22 are overlapped with each other.

As illustrated in FIG. 2, the alignment lid 22 includes an accommodation portion 220 and a support shaft 221. The accommodation portion 220 is a hole portion extending in a width direction (the front-rear direction in FIG. 2) of the alignment lid 22. As illustrated in FIGS. 1 and 2, the accommodation portion 220 is provided at a position facing the magnet M1 in the left-right direction. The accommodation portion 220 is formed so that at least a surface of the alignment lid 22 facing the movable base portion 21 is open. The accommodation portion 220 is configured to accommodate the movable member 23.

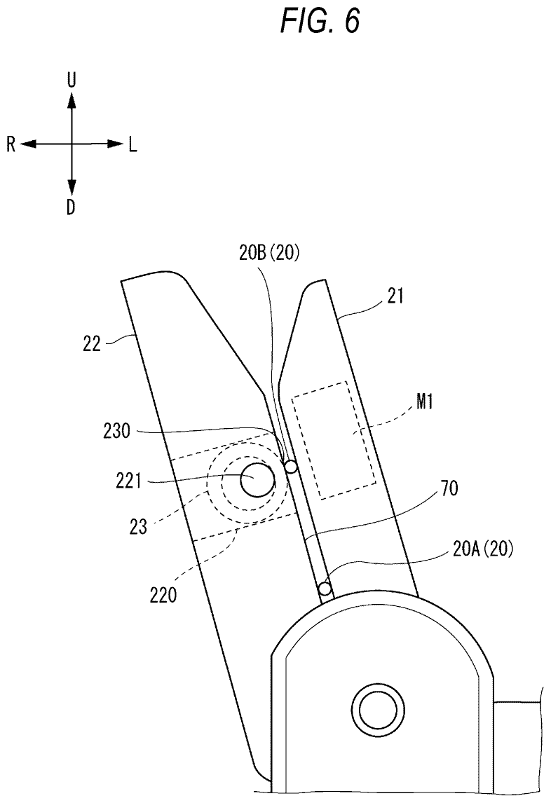

As illustrated in FIG. 2, the support shaft 221 is a cylindrical shaft member that extends in the width direction (the front-rear direction in FIG. 2) of the alignment lid 22. The support shaft 221 passes through the accommodation portion 220 and is fixed to the alignment lid 22 at end surfaces of the alignment lid 22. The support shaft 221 is disposed so as to be covered by the movable member 23 (see FIGS. 5 and 6).

As illustrated in FIG. 1, when the movable base portion 21 and the alignment lid 22 are overlapped with each other, a slit 70 is formed between the movable base portion 21 and the alignment lid 22. The slit 70 has an opening on a side opposite a connection point between the slit 70 and the first base unit 4. The slit is configured to accommodate a plurality of optical fibers 20 in parallel. In addition, on opposing surfaces of the movable base portion 21 and the alignment lid 22, a first tapered surface 71 and a second tapered surface 72 are respectively formed on the opposite side of the connection point with the first base unit 4, which gradually move away from each side edge of the movable base portion 21 and the alignment lid 22. A length D1 (see FIG. 5) in the width direction (left-right direction in FIG. 1) of the slit 70 formed between the opposing surfaces of the movable base portion 21 and the alignment lid 22 is slightly larger than an outer diameter of the optical fiber 20. Therefore, when a plurality of optical fibers 20 are inserted into the slit 70 from the outside of the slit 70, the optical fibers can be inserted one by one in order. When the optical fiber 20 is inserted into the slit 70, the optical fiber 20 is smoothly guided into the slit 70 by the first tapered surface 71 and the second tapered surface 72. The plurality of optical fibers 20 inserted into the slits 70 are accommodated within the slits 70.

As illustrated in FIG. 2, the movable member 23 is, for example, substantially cylindrical. An inner diameter of the movable member 23 is larger than an outer diameter of the support shaft 221. The support shaft 221 is inserted into a space inside the movable member 23. With the movable base portion 21 and the alignment lid 22 overlapping each other, the movable member 23 is movable in a direction away from the slit 70 or in a direction toward the slit 70. In this embodiment, the movable member 23 is movable in a thickness direction (the up-down direction in FIG. 2) of the alignment lid 22 when accommodated in the accommodation portion 220. The movable member 23 is made of a magnetic material such as iron. Therefore, the movable member 23 is attracted toward the movable base portion 21 by the magnetic force of the magnet M1 (see FIG. 1). Therefore, when the movable base portion 21 and the alignment lid 22 are overlapped with each other, the movable member 23 is pulled in a direction to block the slit 70 by the magnetic force of the magnet M1. The movable member 23 has a curved surface 230 (see FIG. 5) that is convex in a direction (leftward in FIG. 5) protruding into the slit 70, when viewed from a depth direction (front-rear direction in FIG. 2) of the slit 70. In other words, the movable member 23 has the curved surface 230 that is convex in the direction protruding into the slit 70, when viewed from a direction parallel to a pivot axis AX1 of the movable base portion 21 and the alignment lid 22. The movable member 23 is rotatable about an axis parallel to the depth direction of the slit 70. In other words, the movable member 23 is rotatable about a rotation axis AX2 that is parallel to the pivot axis AX1 of the movable base portion 21 and the alignment lid 22.

The movable base portion 31, alignment lid 32, and movable member 33 of the second alignment mechanism unit 3 have the same configuration as the movable base portion 21, alignment lid 22, and movable member 23 of the first alignment mechanism unit 2, except that the front-rear direction is inverted, so detailed description is omitted. As illustrated in FIG. 1, a magnet M2 is provided on a surface of the movable base portion 31 facing the second base unit 5.

Next, the first base unit 4 and the second base unit 5 will be described with reference to FIGS. 1 and 2. The base body portion 41 of the first base unit 4 has a substantially rectangular parallelepiped shape. A magnet M3 is provided on an upper surface 410 of the base body portion 41. When the first alignment mechanism unit 2 is pivoted toward the base body portion 41, that is, when the first alignment mechanism unit 2 is displaced from a state illustrated in FIG. 1 to a state illustrated in FIG. 2, the movable base portion 21 is pulled toward the base body portion 41 by the magnetic force between the magnets M1 and M3. The magnetic force of the magnet M1 acts indirectly on the alignment lid 22 via the movable base portion 21 made of a non-magnetic material. Therefore, the force acting on the alignment lid 22 to pull it to the movable base portion 21 due to the magnetic force of the magnet M1 is weaker than the force acting on the movable base portion 21 to pull it to the first base unit 4 due to the magnetic force between the magnets M1 and M3.

The leg portions 42 are provided on both the left and right sides of the base body portion 41. A length of the leg portion 42 in a height direction (the up-down direction in FIGS. 1 and 2) becomes shorter as it becomes farther away from the base body portion 41. A hollow portion 421 is provided in the upper surface 420 of the leg portion 42.

The support portion 43 is provided on a front side of the base body portion 41. The support portion 43 is a plate-like member of which an upper end portion is arc-shaped. A first support hole 430 is provided in an upper portion of the support portion 43. The first support hole 430 is, for example, circular.

As illustrated in FIG. 1, the rail portion 44 is, for example, substantially cylindrical. The rail portion 44 is supported by the first support hole 430 provided in the support portion 43 and a second support hole 450 provided in the restricting portion 45. The movable base portion 21 and the alignment lid 22 of the first alignment mechanism unit 2 are rotatably connected to the rail portion 44. The rail portion 44 is a shaft member of the pivot axis AX1 of the movable base portion 21 and the alignment lid 22. The movable base portion 21 and the alignment lid 22 is configured to be moved along an axial direction (the front-rear direction in FIG. 1) of the pivot axis AX1 of the movable base portion 21 and the alignment lid 22 via the rail portion 44.

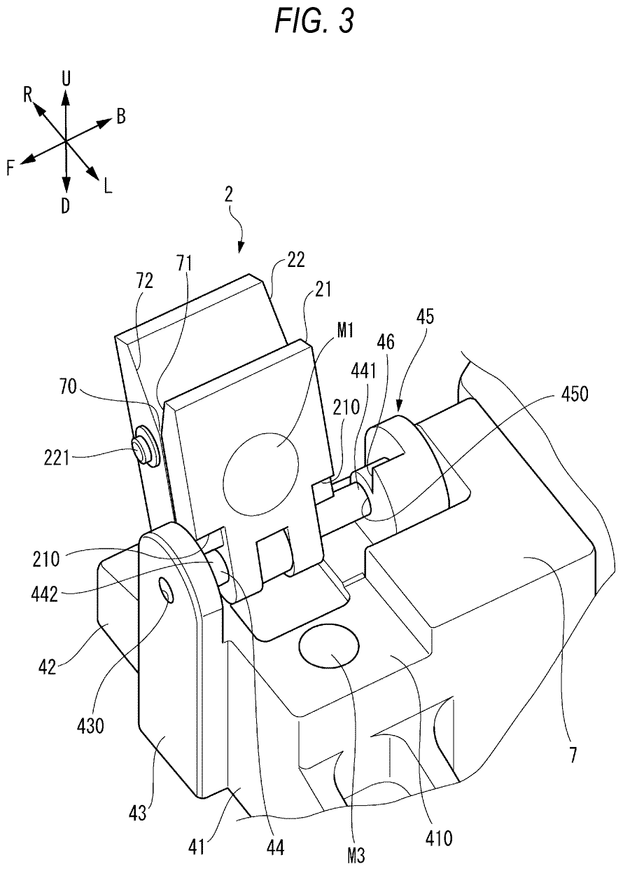

As illustrated in FIG. 3, the restricting portion 45 is provided at a first end 441 (an example of a first position) of the rail portion 44. The first end 441 is provided at a position facing the support portion 43 with respect to the base body portion 41. That is, in this embodiment, the first end 441 is provided at a rear end of the rail portion 44. Further, a second end 442 (an example of a second position) is provided at a position on the rail portion 44 opposite to the first end 441. That is, in this embodiment, the second end 442 is provided at a front end of the rail portion 44.

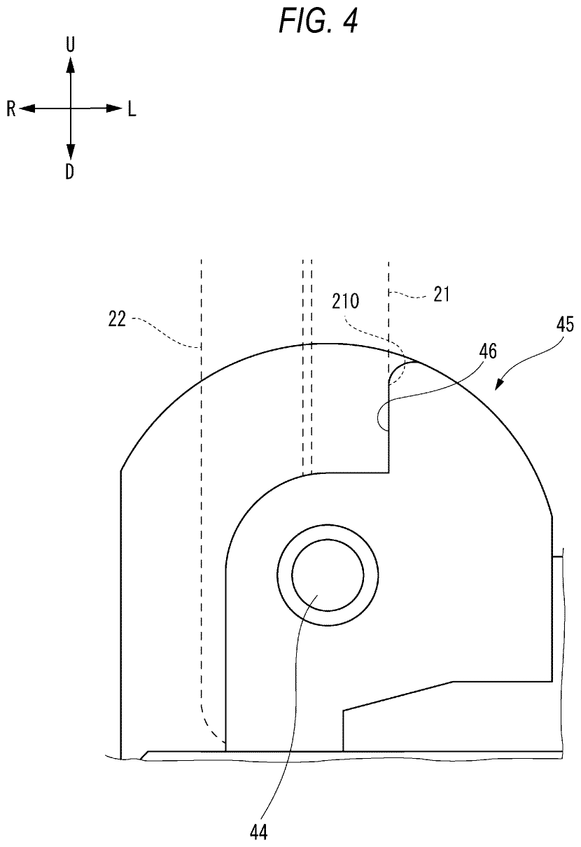

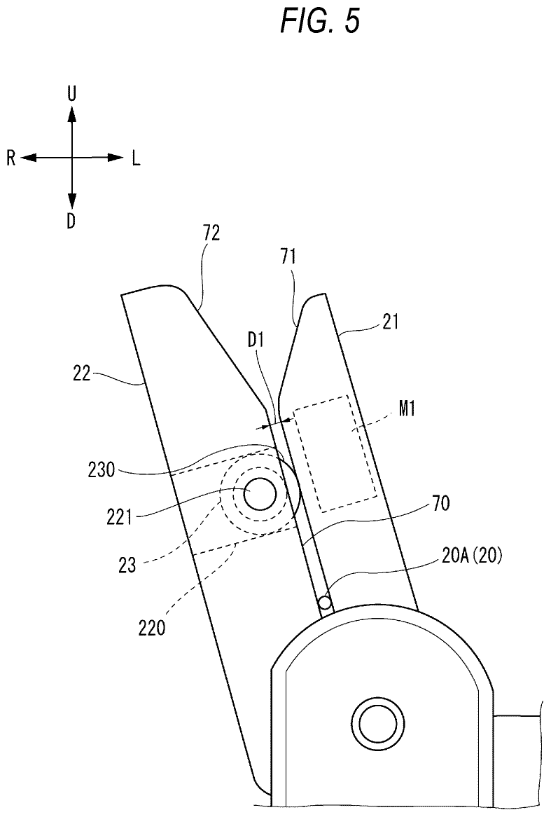

The restricting portion 45 is provided with a stepped portion 46 having a step shape. The shape of the stepped portion 46 is complementary to the shape of the cutout portion 210 of the movable base portion 21. Therefore, for example, when the movable base portion 21 and the alignment lid 22 are overlapped with each other and moved from the second end 442 to the first end 441, and the movable base portion 21 and the alignment lid 22 pivot toward the base body portion 41, the cutout portion 210 abuts against the stepped portion 46, as illustrated in FIG. 4. Therefore, the pivoting of the movable base portion 21 and the alignment lid 22 is restricted by the restricting portion 45. In other words, the restricting portion 45 can restrict the pivoting of the movable base portion 21 and the alignment lid 22. In this manner, the pivoting of the movable base portion 21 and the alignment lid 22 is restricted by the restricting portion 45, so that the movable base portion 21 and the alignment lid 22 are maintained in a state where they are overlapped with each other.

The base body portion 51, leg portions 52, support portion 53, rail portion 54, and restricting portion 55 of the second base unit 5 have the same configuration as the base body portion 41, leg portion 42, support portion 43, rail portion 44, and restricting portion 45 of the first base unit 4, but with the front-rear direction reversed, so detailed descriptions are omitted. As illustrated in FIG. 1, a magnet M4 is provided on an upper surface 510 of the base body portion 51.

As illustrated in FIGS. 1 and 2, the placement unit 6 is configured so that an optical fiber holder (not illustrated) for holding a plurality of optical fibers can be placed thereon. The placement unit 6 is provided between the first alignment mechanism unit 2 and the second alignment mechanism unit 3. The placement unit 6 has a substantially rectangular parallelepiped shape. The placement unit 6 has a substantially square shape when viewed from above. Four corners of the placement unit 6 are rounded. However, the four corners of the placement unit 6 may be angular. A length of the placement unit 6 in the left-right direction is longer than a length of the base body portion 41 in the left-right direction. A protrusion 61 is provided on an upper surface portion 60 of the placement unit 6. The protrusion 61 protrudes upward from the upper surface portion 60. For example, the optical fiber holder is positioned with respect to the placement unit 6 by inserting the protrusion 61 into a hole provided in a bottom surface of the optical fiber holder, and the optical fiber holder is thereby placed on the placement unit 6.

The first connecting unit 7 is substantially L-shaped in top view. The first connecting unit 7 is provided between the first base unit 4 and the placement unit 6. The first connecting unit 7 is configured to connect the first base unit 4 and the placement unit 6.

The second connecting unit 8 is substantially L-shaped in top view. The second connecting unit 8 is provided between the second base unit 5 and the placement unit 6. The second connecting unit 8 is configured to connect the second base unit 5 and the placement unit 6.

Next, a state where the optical fiber 20 is accommodated in the slit 70 will be described with reference to FIGS. 5 and 6. FIG. 5 is a diagram illustrating a state where the movable base portion 21 and the alignment lid 22 are overlapped with each other and the movable member 23 is in an initial state position. The initial state refers to a state where the movable base portion 21 and the alignment lid 22 are overlapped with each other, and the magnetic force of the magnet M1 acts on the movable member 23, pulling it so that the movable member 23 is displaced toward the movable base portion 21. FIG. 6 is a diagram illustrating a state in which the movable base portion 21 and the alignment lid 22 are overlapped with each other, and the movable member 23 is pressed in a direction to open the slit 70 and moves in a direction away from the slit 70.

As illustrated in FIG. 5, in the initial state, the movable member 23 is pulled in a direction to block the slit 70 by the magnetic force of the magnet M1 provided on the movable base portion 21, so that a part of the movable member 23 protrudes to block the slit 70. Therefore, in the state illustrated in FIG. 5, the movable member 23 prevents an optical fiber 20A accommodated in the slit 70 from jumping out (upward in FIG. 5) of the slit 70.

When the movable member 23 is in the initial state, if an optical fiber 20B (see FIG. 6) is inserted toward the slit 70 from the outside (upper side in FIG. 5) of the slit 70, the optical fiber 20B comes into contact with the curved surface 230 of the movable member 23. After the optical fiber 20B comes into contact with the curved surface 230, when an attempt is made to move the optical fiber 20B further inwardly (downward in FIG. 5) into slit 70, as illustrated in FIG. 6, the movable member 23 is pressed in the direction (to the right in FIG. 6) to open the slit 70 and moves in the direction (to the right in FIG. 6) away from the slit 70. When the movable member 23 moves in a direction away from the slit 70, a gap large enough for the optical fiber 20B to pass through is formed in the slit 70, so that the optical fiber 20B can be moved below the movable member 23. In this way, in the alignment member 1, even when the movable base portion 21 and the alignment lid 22 are overlapped with each other, the optical fiber 20B can be accommodated in the slit 70 by contacting and pressing the optical fiber 20B against the movable member 23. By repeating this operation and accommodating a plurality of (for example, 12) optical fibers 20 in the slit 70, the plurality of optical fibers 20 can be aligned in a row.

After the plurality of optical fibers 20 are aligned by the first alignment mechanism unit 2 and the second alignment mechanism unit 3, the movable base portion 21 and the alignment lid 22 are moved to the second end 442 while the movable base portion 21 and the alignment lid 22 are overlapped, and the movable base portion 31 and the alignment lid 32 are moved to the second end 442 while the movable base portion 31 and the alignment lid 32 are overlapped. Next, the movable base portion 21 and the alignment lid 22 are tilted onto the base body portion 41, and the movable base portion 31 and the alignment lid 32 are tilted onto the base body portion 51. This allows the plurality of aligned optical fibers 20 to be set in the optical fiber holder that is placed in advance on the placement unit 6.

According to the alignment member 1 as described above, when the optical fibers 20 are brought into contact with and pressed against the movable member 23, the movable member 23 moves in a direction to open the slit 70, so that the optical fibers 20 can be accommodated in the slit 70. After the optical fiber 20 is accommodated, the movable member 23 is pulled in a direction to block the slit 70, so that a part of the movable member 23 protrudes to block the slit 70. Therefore, the optical fiber 20 can be accommodated in the slit 70 simply by moving the movable member 23, and there is no need to apply force to the movable base portion 21 and the alignment lid 22. In other words, the slit 70 can be kept blocked without applying force to the movable base portion 21 and the alignment lid 22, so that the aligned state of the optical fibers 20 accommodated in the slit 70 can be maintained. Therefore, the alignment member 1 can reliably align the plurality of optical fibers 20.

Furthermore, according to the alignment member 1 as described above, the movable member 23 has the curved surface 230 that is convex in the direction protruding into the slit 70 when viewed from the depth direction of the slit 70. Therefore, according to the alignment member 1, the movable member 23 can be easily pressed by the optical fibers 20, and therefore the movable member 23 can be easily moved in a direction (in a direction to open the slit 70) away from the slit 70.

Furthermore, according to the alignment member 1 as described above, the movable member 23 is rotatable about an axis parallel to the depth direction of the slit 70. Therefore, according to the alignment member 1, even when the optical fiber 20 comes into contact with the movable member 23, excessive frictional force is unlikely to be generated on the optical fiber 20, so the optical fiber 20 is unlikely to be damaged and the optical fiber 20 can be easily accommodated in the slit 70.

Furthermore, according to the alignment member 1 described above, when the movable base portion 21 and the alignment lid 22 move to the first end 441 (an example of the first position) of the rail portion 44 via the rail portion 44, the pivoting of the movable base portion 21 and the alignment lid 22 is restricted by the restricting portion 45, so that the slit 70 does not widen. That is, the length D1 (see FIG. 5) of the slit 70 in the width direction (the left-right direction in FIG. 1) does not become large. In other words, by simply moving the movable base portion 21 and the alignment lid 22 to the first end 441 of the rail portion 44, the movable base portion 21 and the alignment lid 22 can be maintained in a state of being overlapped with each other. Therefore, according to the alignment member 1, the pivoting of the movable base portion 21 and the alignment lid 22 is restricted by the restricting portion 45, so that the slit 70 does not widen, which improves workability when accommodating the optical fibers 20 in the slit 70 and makes it possible to maintain the aligned state of the optical fibers 20.

Furthermore, according to the alignment member 1 described above, the rail portion 44 is a shaft member of the pivot axis AX1 of the movable base portion 21 and the alignment lid 22, so that the configuration of the alignment member 1 can be simplified while reliably aligning a plurality of optical fibers 20.

Furthermore, according to the alignment member 1 described above, the plurality of optical fibers 20 can be aligned from both sides in advance before the plurality of optical fibers 20 are held in the optical fiber holder, making it easier to hold the plurality of optical fibers 20 in the optical fiber holder.

Furthermore, according to the alignment member 1 as described above, the movable member 23 is pulled in a direction to block the slit 70 by the magnetic force of the magnet M1, and is thereby arranged in the initial state position. Therefore, according to the alignment member 1, the slits 70 can be stably blocked by simple means.

### Second Embodiment

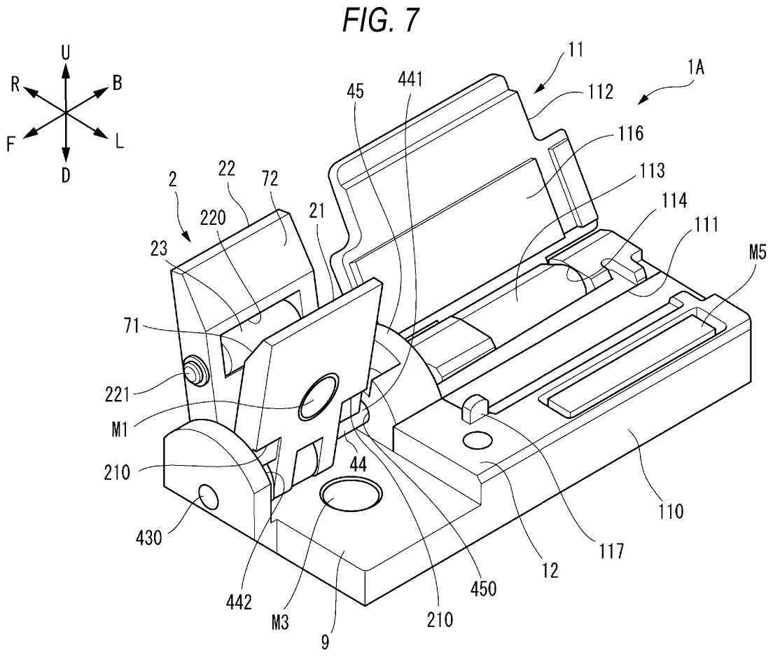

Next, an alignment member 1A according to a second embodiment will be described with reference to FIG. 7. In the second embodiment, the same parts as those in the first embodiment are denoted by the same reference numerals, and the description thereof will be omitted as appropriate. The alignment member 1A is for aligning a plurality of single optical fibers in parallel and for holding the plurality of optical fibers. As illustrated in FIG. 7, the alignment member 1A includes a first alignment mechanism unit 2, a base unit 9, a holding mechanism unit 11, and a connecting unit 12.

The base unit 9 differs from the first base unit 4 in that it does not have leg portions and that its length in the height direction (the up-down direction in FIG. 7) is shorter than the length in the height direction (the up-down direction in FIG. 1) of the first base unit 4.

However, in other respects the base unit 9 is similar to the first base unit 4, so a detailed description will be omitted.

The holding mechanism unit 11 is configured to hold a plurality of optical fibers 20 (see FIGS. 1 and 2). The first alignment mechanism unit 2 and the holding mechanism unit 11 are arranged side by side in a longitudinal direction of the optical fiber 20 held by the holding mechanism unit 11. As illustrated in FIG. 7, the holding mechanism unit 11 is disposed behind the first alignment mechanism unit 2. The holding mechanism unit 11 includes a holder body 110, an accommodating groove 111, and a holding lid 112. The holder body 110 has a substantially rectangular parallelepiped shape. The holder body 110 is provided rearward of the base unit 9. The holder body 110 is provided with a magnet M5 on an upper surface on an opposite side (left side) to one side (right side) to which the holding lid 112 is connected.

The accommodating groove 111 is provided on an upper surface of the holder body 110. The accommodating groove 111 is a groove for accommodating a plurality of optical fibers 20 in parallel. In this embodiment, a plurality of optical fibers 20 that are maintained in an aligned state by the first alignment mechanism unit 2 are accommodated in the accommodating groove 111. The holding lid 112 is provided on one side (right side) of the holder body 110.

The holding lid 112 includes a hinge portion 113. The hinge portion 113 is disposed in a holding groove 114 formed in the holder body 110. The holder body 110 is provided with a connecting pin (not illustrated) that passes through the holding groove 114. The connecting pin is inserted into an insertion hole (not illustrated) formed in the hinge portion 113. As a result, the holding lid 112 is connected to the holder body 110 so as to be pivotable within a range of approximately 180°around an axis of the connecting pin provided on the holder body 110. Therefore, by pivoting the holding lid 112, the upper surface of the holder body 110 can be opened and closed. The holding lid 112 pivots toward the upper surface side of the holder body 110 so as to be disposed to cover an upper part of the accommodating groove 111.

The holding lid 112 is provided with a pressing plate portion 116 on a surface facing the holder body 110, the pressing plate portion 116 being made of an elastic material such as rubber. When the holding lid 112 pivots toward the upper surface side of the holder body 110, the pressing plate portion 116 is disposed above the accommodating groove 111.

The holding lid 112 is made of a magnetic material such as iron. When the holding lid 112 is placed on the upper surface of the holder body 110, the holding lid 112 comes into contact with or close to the magnet M5. When the holding lid 112 is placed on the upper surface of the holder body 110, the holding lid 112 is pulled toward the holder body 110 by a magnetic force of the magnet M5. In this manner, the holding lid 112 is pulled toward the holder body 110 by the magnetic force of the magnet M5, so that the optical fiber 20 accommodated in the accommodating groove 111 is pressed by the holding lid 112 and held therein.

A guide portion 117 is provided on the upper surface of the holder body 110 at a position where the holding lid 112 does not overlap. The guide portion 117 is provided on an edge portion of the accommodating groove 111 that is located on the opposite side to the connection side between the holder body 110 and the holding lid 112, among edge portions of the accommodating groove 111.

The connecting unit 12 is provided between the base unit 9 and the holder body 110. The connecting unit 12 is configured to connect the base unit 9 and the holder body 110.

As for an operating procedure of the alignment member 1A, first, with the holding lid 112 open, the first alignment mechanism unit 2 aligns a plurality of optical fibers 20 in the same manner as in the first embodiment. Next, with the movable base portion 21 and the alignment lid 22 overlapping each other, the movable base portion 21 and the alignment lid 22 are moved from the first end 441 (an example of the first position) to the second end 442 (an example of the second position) and tilted down onto the base unit 9. As a result, the plurality of optical fibers 20 are accommodated in the accommodating groove 111 in an aligned state. Next, by closing the holding lid 112, the plurality of aligned optical fibers 20 can be held in the holding mechanism unit 11, and the plurality of optical fibers 20 can be set together with the alignment member 1A in a subsequent fusion splicer or the like.

The alignment member 1A according to the second embodiment can also achieve the same effects as the alignment member 1 according to the first embodiment.

Furthermore, according to the alignment member 1A described above, the first alignment mechanism unit 2 and the holding mechanism unit 11 are arranged side by side in the longitudinal direction of the optical fiber 20 held by the holding mechanism unit 11, so that alignment and holding of the plurality of optical fibers 20 can be performed by the single alignment member 1A.

Although the present disclosure is described in detail and with reference to specific embodiments, it will be apparent to those skilled in the art that various changes and modifications can be made without departing from the spirit and scope of the present disclosure. Furthermore, the numbers, positions, shapes, and the like of the components described above are not limited to the above embodiments, and may be changed to any number, position, shape, or the like that is suitable for implementing the present disclosure.

In the above embodiment, the state in which the movable member 23 protrudes to block the slit 70 in the initial state is achieved by the magnetic force of the magnet M1, but the state may also be achieved by an elastic force of an elastic member such as a spring. In other words, the movable member 23 may be biased in a direction to block the slit 70 by the elastic force of an elastic member such as a spring, so that at least a part of the movable member 23 protrudes so as to narrow or block the slit 70. In this case, an elastic force acts on the movable member 23 from the movable base portion 21 towards the alignment lid 22 or from the alignment lid 22 towards the movable base portion 21.

In the above embodiment, the movable member 23 is accommodated in the accommodation portion 220 formed in the alignment lid 22, but the movable member 23 may also be accommodated in an accommodation portion formed in the movable base portion 21, for example, or the movable member 23 may be accommodated so as to straddle both the accommodation portion 220 and the accommodation portion formed in the movable base portion 21.

In the embodiment described above, the movable base portion 21 and the alignment lid 22 move along the axial direction of the pivot axis AX1 via the rail portion 44, but the movable base portion 21 and the alignment lid 22 may also move along the axial direction of the pivot axis AX1 via, for example, a slider provided on the base body portion 41.

In the embodiment described above, the restricting portion 45 is provided at the first end 441 of the rail portion 44, but the restricting portion may be provided at another position, for example, between the first end 441 and the second end 442. In this case, the other position is an example of the first position.

In the embodiment described above, the movable base portion 21 and the alignment lid 22 are overlapped with each other and moved from the second end 442 to the first end 441, thereby restricting the pivoting of the movable base portion 21 and the alignment lid 22 by the restricting portion 45, but the present disclosure is not limited to this. For example, with the movable base portion 21 and the alignment lid 22 overlapping with each other, the movable base portion 21 and the alignment lid 22 may be moved from a first intermediate position (an example of the first position) between the first end 441 and the second end 442 to a second intermediate position (an example of the second position), whereby the pivoting of the movable base portion 21 and the alignment lid 22 may be restricted by the restricting portion 45 provided at the second intermediate position.

In the embodiment described above, the movable member 23 protrudes so as to block the slit 70 in the initial state, but the slit 70 does not have to be completely blocked by the movable member 23. For example, in the initial state, the movable member 23 may protrude so as to narrow or block the slit 70 to such an extent that a gap between the movable member 23 and the movable base portion 21 is smaller than the outer diameter of the optical fiber 20 to be aligned.

In the embodiment described above, a part of the movable member 23 protrudes so as to block the slit 70 in the initial state, but the entirety of the movable member 23 may protrude so as to block the slit 70.

In the embodiment described above, the movable base portion 21 and the alignment lid 22 are connected to the first base unit 4, but the present disclosure is not limited thereto. For example, the movable base portion 21 may be pivotally connected to the first base unit 4, while the alignment lid 22 may be pivotally connected to the movable base portion 21. Alternatively, the alignment lid 22 may be pivotally connected to the first base unit 4, while the movable base portion 21 may be pivotally connected to the alignment lid 22. In either case, the alignment lid 22 is pivotable relative to the movable base portion 21. In either case, the movable base portion 21 and the alignment lid 22 are pivotable relative to the first base unit 4.

In the embodiment described above, the pivot axis of the movable base portion 21 and the alignment lid 22 are the same axis, but the pivot axis of the movable base portion 21 and the pivot axis of the alignment lid 22 may be different pivot axes.

In the embodiment described above, the movable member 23 rotates about the rotation axis AX2, but it is sufficient that the movable member 23 rotates about an axis parallel to the depth direction of the slit 70, and is not limited to rotating about the rotation axis AX2.

In the embodiment described above, the movable member 23 is attracted toward the movable base portion 21 by the magnetic force of the magnet M1, but the movable member 23 may also be attracted toward the movable base portion 21 by, for example, the magnetic force of a magnet other than the magnet M1. Even in this case, when the movable base portion 21 and the alignment lid 22 are overlapped with each other, the movable member 23 is pulled in a direction to block the slit 70 by the magnetic force of the other magnet.

In the second embodiment, the first alignment mechanism unit 2 is provided in front of the connecting unit 12, and the holding mechanism unit 11 is provided behind the connecting unit 12. However, the first alignment mechanism unit 2 may be provided behind the connecting unit 12, and the holding mechanism unit 11 may be provided in front of the connecting unit 12.

### REFERENCE SIGNS LIST

1, 1A: alignment member
2: first alignment mechanism unit
3: second alignment mechanism unit
4: first base unit
5: second base unit
6: placement unit
7: first connecting unit
8: second connecting unit
9: base unit
11: holding mechanism unit
12: connecting unit
20, 20A, 20B: optical fiber
21, 31: movable base portion
22, 32: alignment lid
23, 33: movable member
41, 51: base body portion
42, 52: leg portion
43, 53: support portion
44, 54: rail portion
45, 55: restricting portion
46: stepped portion
60: upper surface portion
61: protrusion
70: slit
71: first tapered surface
72: second tapered surface
110: holder body
111: accommodating groove
112: holding lid
113: hinge portion
114: holding groove
116: pressing plate portion
117: guide portion
210: cutout portion
220: accommodation portion
221: support shaft
230: curved surface
410, 510: upper surface of base body portion
420: upper surface of leg portion
421: hollow portion
430: first support hole
441: first end
442: second end
450: second support hole
AX1, AX2: pivot axis
M1, M2, M3, M4, M5: magnet

What is claimed is:

1. An alignment member comprising:
a base unit; and
an alignment mechanism unit including:
a movable base portion disposed overlapping the base unit;
an alignment lid disposed overlapping the movable base portion; and
a movable member provided in at least one of the movable base portion and the alignment lid,
wherein the movable base portion is pivotally connected to the base unit,
the alignment lid is configured to be pivoted relative to the movable base portion,
when the movable base portion and the alignment lid are overlapped with each other, a slit is formed between the movable base portion and the alignment lid, the slit being open on a side opposite to a connection point between the slit and the base unit and being configured to accommodate a plurality of optical fibers in parallel,
in an initial state, the movable member is pulled or biased in a direction to block the slit, and at least a part of the movable member protrudes so as to narrow or block the slit, and
the movable member is configured to be moved in a direction away from the slit when pressed.

2. The alignment member according to claim 1, wherein the movable member has a curved surface that is convex in a direction protruding toward the slit, when viewed from a depth direction of the slit.

3. The alignment member according to claim 1, wherein the movable member is configured to be rotated about an axis parallel to a depth direction of the slit.

4. The alignment member according to claim 1,
wherein a pivot axis of the movable base portion and a pivot axis of the alignment lid are the same axis,
the base unit includes:
a rail portion for moving the movable base portion and the alignment lid along the pivot axis of the movable base portion and the alignment lid; and
a restricting portion for restricting pivoting of the movable base portion and the alignment lid,
the restricting portion is provided at a first position of the rail portion, and
when the movable base portion and the alignment lid is moved to the first position via the rail portion, the pivoting of the movable base portion and the alignment lid is restricted by the restricting portion, and the movable base portion and the alignment lid are maintained in an overlapped state.

5. The alignment member according to claim 4, wherein the rail portion is a shaft member of the pivot axis.

6. The alignment member according to claim 1, comprising:
two alignment mechanism units; and
a placement unit for placing an optical fiber holder configured to hold the plurality of optical fibers,
wherein the placement unit is provided between the two alignment mechanism units.

7. The alignment member according to claim 1, further comprising:
a holding mechanism unit for holding the plurality of optical fibers,
wherein the alignment mechanism unit and the holding mechanism unit are arranged side by side in a longitudinal direction of the optical fiber held by the holding mechanism unit.

8. The alignment member according to claim 1, wherein the movable member is arranged in an initial state position by being pulled in a direction to block the slit by a magnetic force.
